(19) United States
(12) Patent Application Publication
(10) Pub. No.: US 2026/0243436 A1
(43) Pub. Date: Aug. 20, 2026

(54) COOKING APPLIANCE AND METHOD FOR DETERMINING TEMPERATURE OF A COOKWARE ITEM

(71) Applicant: Haier US Appliance Solutions, Inc., Wilmington, DE (US)

(72) Inventor: Omar Santana, Louisville, KY (US)

(21) Appl. No.: 19/056,866

(22) Filed: Feb. 19, 2025

(51) Int. Cl. F24C 7/08; F24C 15/10; H05B 6/12

(52) U.S. Cl. CPC F24C 7/088; F24C 7/083; F24C 15/102; H05B 6/1209

(57) ABSTRACT

A method of operating a cooking appliance may include obtaining a temperature setpoint. The method may include initiating a hot cookware detection operation across a detection period in response to obtaining the temperature setpoint. The method may include obtaining, by a temperature sensor, a first temperature value corresponding to a cooking surface at a start of the detection period. The method may include obtaining, by the temperature sensor, a second temperature value corresponding to the cooking surface at an end of the detection period. The method may include determining, based on the first temperature value and the second temperature value, a temperature change at the cooking surface. The method may include determining, based on at least one of the temperature change, the first temperature value, and the second temperature value, a cookware temperature value corresponding to a temperature of a cookware item at the cooking surface.

### FIELD OF THE DISCLOSURE

The present subject matter relates generally to a cooking appliance and more particularly to methods for determining temperature of a cookware item.

### BACKGROUND OF THE DISCLOSURE

Cooking appliances generally have one or more heating elements configured for heating a cookware item. The cookware item, e.g., a pot, a pan, or the like, may be positioned on or near the one or more heating elements and food products (e.g., food solids, liquids, or the like) may be placed inside the cookware item for cooking. A controller may selectively energize the heating element(s) to provide thermal energy to the cookware item and the food products placed therein. Alternatively, certain cooking appliances, often referred to as induction cooktops, provide energy in the form of an alternating magnetic field which causes the cookware item to generate heat. In both types of appliances, a controller selectively energizes either the heating element(s) or a magnetic coil to heat the food products (e.g., until they are properly cooked).

For cooking appliances that are capable of performing feedback controlled heating operations, one or more algorithms may be used to incorporate certain feedback information (e.g., temperature change, temperature rate of change, etc.) over a heating period to intelligently control a power level of the heating element(s). However, it can be difficult to accurately control a temperature of cookware items during portions of heating operation, such as the feedback controlled heating operation. For instance, slow sensor response can be present at a start of a heating operation, resulting in significant difference between a temperature reading at a temperature sensor of the heating element and the actual temperature of the cookware item on the heating element. This can result in undesirable heating behaviors, such as excessive temperature overshoots, long heat rise times, and the like.

Accordingly, a cooking appliance and method of operating a cooking appliance that obviates one or more of the above-mentioned drawbacks would be desirable.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a cooking appliance is provided. The cooking appliance may include at least one heating element configured for selectively supplying heat to a cookware item placed on a cooking surface. The cooking appliance may include a temperature sensor configured to selectively monitor a temperature of the cooking surface. The cooking appliance may include a controller operably connected with the at least one heating element and the temperature sensor. The controller configured for performing operations. The operation may include obtaining a temperature setpoint, initiating a hot cookware detection operation across a detection period in response to obtaining the temperature setpoint, obtaining, at the temperature sensor, a first temperature value corresponding to the cooking surface at a start of the detection period, obtaining, at the temperature sensor, a second temperature value corresponding to the cooking surface at an end of the detection period, determining, based on the first temperature value and the second temperature value, a temperature change at the cooking surface, and determining, based on at least one of the temperature change, the first temperature value, and the second temperature value, a cookware temperature value, the cookware temperature value corresponding to a temperature of a cookware item at the cooking surface.

In another exemplary aspect of the present disclosure, a method of operating a cooking appliance is provided. The method may include obtaining a temperature setpoint. The method may include initiating a hot cookware detection operation across a detection period in response to obtaining the temperature setpoint. The method may include obtaining, by a temperature sensor, a first temperature value corresponding to a cooking surface at a start of the detection period. The method may include obtaining, by the temperature sensor, a second temperature value corresponding to the cooking surface at an end of the detection period. The method may include determining, based on the first temperature value and the second temperature value, a temperature change at the cooking surface. The method may include determining, based on at least one of the temperature change, the first temperature value, and the second temperature value, a cookware temperature value corresponding to a temperature of a cookware item at the cooking surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a side cut-away view of the exemplary cooking appliance of FIG. 1.

FIG. 3 provides a side view of a heating element according to one or more exemplary embodiments of the present subject matter.

FIG. 4 provides a graph illustrating a set of temperature trends across a cooking cycle according to one or more exemplary embodiments of the present subject matter.

FIG. 5 provides a graph illustrating a comparison of a sensor temperature over time for different initial cookware item temperatures according to one or more exemplary embodiments of the present subject matter.

FIG. 6 provides a table illustrating a change in a sensor temperature value across a hot cookware detection operation for different initial cookware and sensor temperatures according to one or more exemplary embodiments of the present subject matter.

FIG. 7 provides a graph illustrating a change in a sensor temperature value across a hot cookware detection operation for different initial cookware and sensor temperatures according to one or more exemplary embodiments of the present subject matter.

FIG. 8 provides a flow chart illustrating a method of operating a cooking appliance according to one or more exemplary embodiments of the present subject matter.

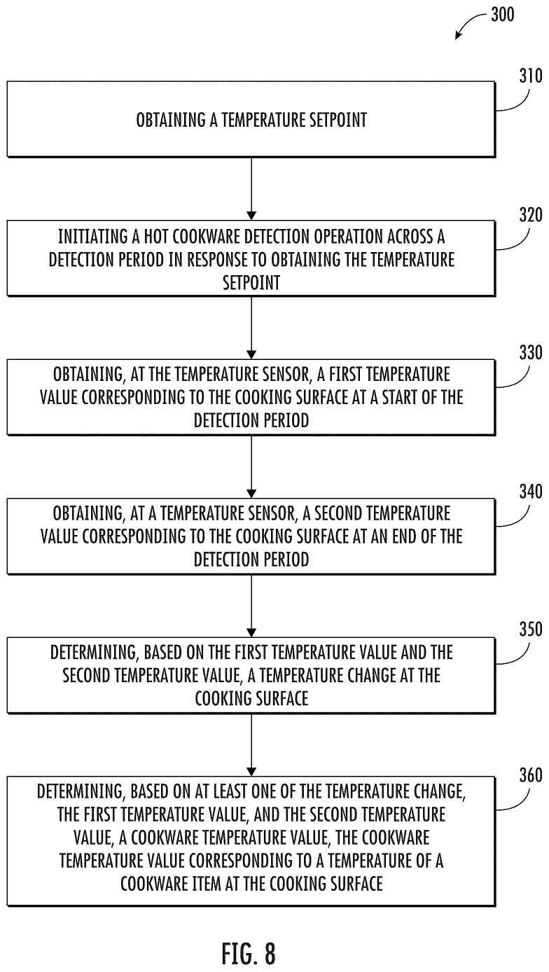

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

In many existing cooking appliances, and specifically in existing cooking appliances that include induction cooktops, a temperature sensor is located under the cooking surface at a heating element. Such temperature sensors can directly sense a temperature of the heating element or cooking surface and indirectly sense a temperature of a cookware item on the heating element. The temperature of the cookware item can be utilized in various cooking cycles, such as a feedback controlled cooking cycle to accurately control the temperature of the cookware item. However, when there is a large difference between the actual temperature of the cookware item and the temperature measured by the temperature sensor (e.g., the temperature of the cooking surface), the temperature sensor may not accurately sense the temperature of the cookware item. For example, when a cookware item that is hot (e.g., at a temperature above an ambient temperature) is placed on a heating element's cooking surface that is at an ambient temperature or when a cookware item that has a temperature that is below the temperature of the cooking surface is placed on the cooking surface, the temperature at the temperature sensor may not be an accurate representation of the temperature at the cookware item, due to the large difference in temperature. This can result in inaccurate temperature values being associated with the cookware item and thus excessive temperature overshoots, long heat rise times, or the like.

Accordingly, embodiments of the present disclosure provide a hot cookware detection operation that occurs prior to a preheating or cooking operation of a cooking cycle. Notably, the hot cookware detection operation is utilized to advantageously calibrate the cooking cycle prior to the preheating or cooking operation. In this regard, when there is a large differential between the temperature of a cookware item and a cooking surface, the cooking cycle may advantageously be calibrated to include information corresponding to this temperature differential.

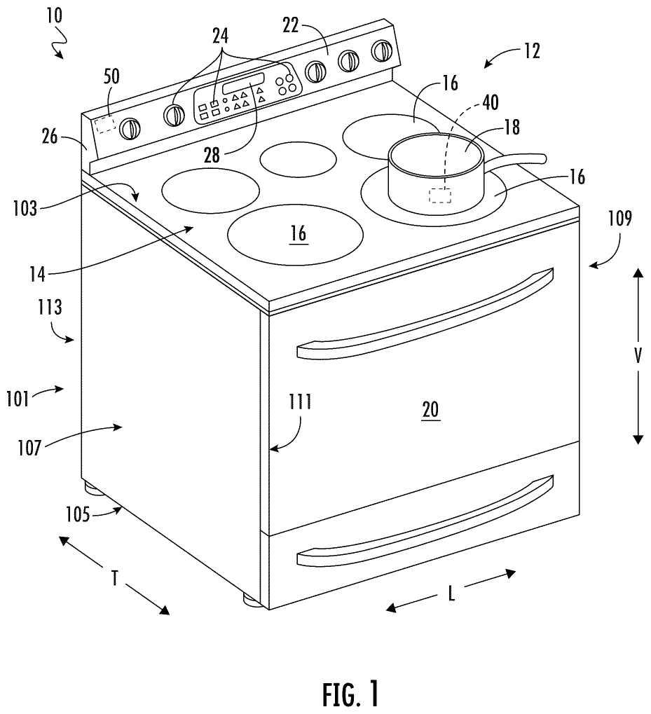

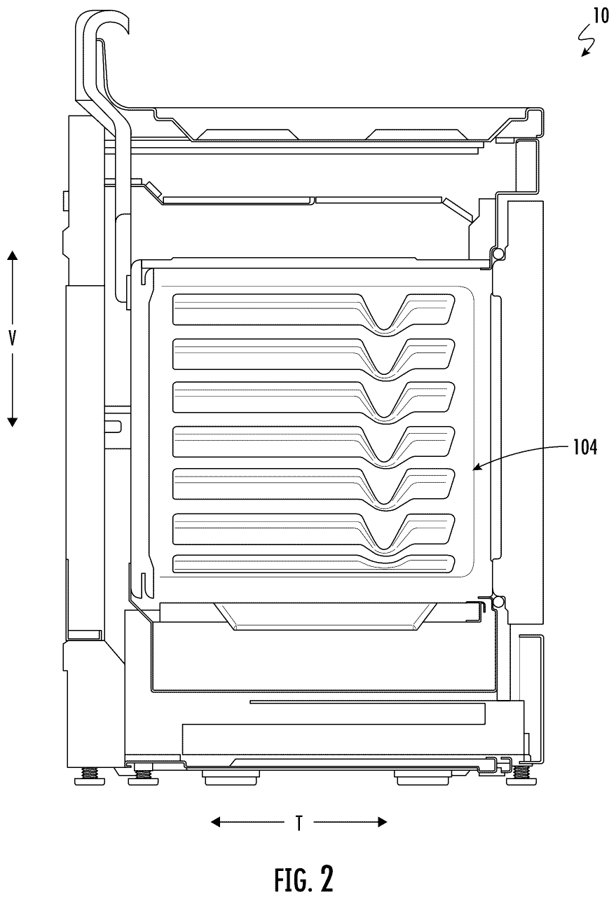

Referring now to FIGS. 1 and 2, embodiments of a cooking appliance 10, such as an oven range, are provided. In particular, FIG. 1 provides a perspective view of the cooking appliance 10 including a cooktop 12, and FIG. 2 provides a side cut-away view of the cooking appliance 10. Cooking appliance 10 is provided by way of example only and is not intended to limit the present subject matter to the arrangement shown in FIGS. 1 and 2. Thus, the present subject matter may be used with other range or cooktop configurations, e.g., double oven range appliances. As illustrated, cooking appliance 10 generally defines a vertical direction V, a lateral direction L, and a transverse direction T, each of which is mutually perpendicular, such that an orthogonal coordinate system is generally defined. Cooking appliance 10 may include a cabinet 101 that extends between a top 103 and a bottom 105 along the vertical direction V, between a left side 107 and a right side 109 along the lateral direction, and between a front 111 and a rear 113 along the transverse direction T.

A cooking surface 14 of cooktop 12 may include a plurality of heating elements 16. In the exemplary embodiments, the cooktop 12 includes five heating elements 16 spaced along cooking surface 14. In the exemplary embodiments, the cooktop 12 is provided as an induction cooktop. For instance, the heating elements 16 may include or be provided as induction heating elements (e.g., described in more detail below). However, in other embodiments, the cooktop 12 includes other suitable shape, configuration, or number of heating elements 16, for example, cooktop 12 may be an open coil cooktop with heating elements 16 positioned on or above surface 14. Additionally or alternatively, in other embodiments, cooktop 12 may include any other suitable type of heating element 16, such as a radiant heating element. Each of the heating elements 16 may be the same type of heating element 16, or cooktop 12 may include a combination of different types of heating elements 16.

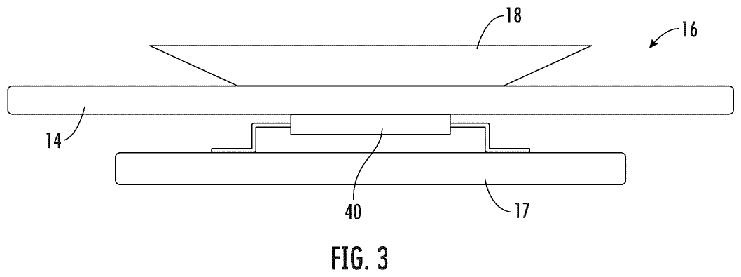

Referring now to FIG. 3, a side view of a particular heating element 16 is provided. As mentioned above, the exemplary heating element 16 may be configured as an induction style heating element. In some embodiments, the heating element 16 includes a coil 17, such as a copper coil, a Lenz coil, or the like, that utilizes electromagnetic induction to heat electrically conductive materials, such as metal materials in cookware items 18 (e.g., described in more detail below). The coil 17 may be mounted to the cooking surface 14, for instance, below the cooking surface 14. As such, current may pass through the coil 17 to generate a magnetic field. The magnetic field may be a high frequency circulating magnetic field. The magnetic field may be directed towards and through cooktop 12 to a cookware item 18, such as a pot, pan, or the like, placed on the cooktop 12 above the heating element 16. As should be appreciated, the cookware item 18 may include or be constructed from a magnetic metal material, such as stainless steel, cast iron, enameled iron, a nickel based metal, or the like. Thus, when the magnetic field penetrates cookware item 18, the magnetic field induces a circulating electrical current within cookware item 18. The material properties of cookware item 18 may restrict a flow of the induced electrical current and convert the induced electrical current into heat within cookware item 18. As cookware item 18 heats up, contents of cookware item 18 contained therein heat up as well. In such a manner, the heating element 16 can cook the contents of cookware item 18.

Moreover, the cooking appliance 10, and more particularly, the heating element 16 may include one or more temperature sensors 40. Temperature sensors 40 may be configured to selectively sense a temperature of the cooktop 12 (e.g., of cooking surface 14). For instance, each temperature sensor 40 may be disposed at the cooktop 12, such as mounted on a heating element 16 under cooking surface 14 of the cooktop 12, to selectively sense a temperature of the cooking surface 14 at the particular heating element. In some embodiments, the temperature sensor may be in direct contact with the cooking surface 14, for instance, at a bottom surface of the cooktop 12. As will be appreciated in more detail below, the temperature sensor 40 may also be utilized in determining the temperature of a particular cookware item 18 that may be positioned at the heating element 16 at various stages of a heating or cooking operation.

As used herein, “temperature sensor” or the equivalent is intended to refer to any suitable type of temperature measuring system or device for measuring the temperature. Thus, for example, temperature sensor 40 may be any suitable type of temperature sensor, such as a thermistor, a thermocouple, a resistance temperature detector, a semiconductor-based integrated circuit temperature sensor, etc., for measuring the temperature of the cooking surface 14. In addition, temperature sensor 40 may output a signal, such as a voltage, to a controller, such as controller 50 described in more detail below, that is proportional to, or indicative of the temperature being measured. Although exemplary positioning of temperature sensors is described herein, it should be appreciated that cooking appliance 10 may include any other suitable number, type, and position of temperature or other sensors according to alternative embodiments.

Referring now back to FIGS. 1 and 2, the cooking appliance 10 may also include a door 20 that permits access to a cooking chamber 104 of cooking appliance 10, e.g., for cooking or baking of food items therein. A control panel 22 having controls 24 may permit a user to make selections for cooking of food items. Although shown on a backsplash or back panel 26 of cooking appliance 10, control panel 22 may be positioned in any suitable location.

Controls 24 may include buttons, knobs, and the like, as well as combinations thereof, or controls 24 may be implemented on a remote user interface device such as a smartphone. As an example, a user may manipulate one or more controls 24 to select a temperature or a heat or power output for each heating element 16 and the cooking chamber 104. The selected temperature or heat output of heating element 16 affects the heat transferred to cookware item 18 placed on heating element 16. A display 28 may be provided (e.g., on or in control panel 22). Display 28 may display information regarding cooking operations or receive inputs from a user regarding the cooking operation. Display 28 may be any suitable display capable of providing visual feedback, such as a liquid crystal display (LCD), a light emitting diode (LED) display, a segmented display, or the like. Additionally or alternatively, display 28 may be a touch display capable of receiving touch inputs from a user.

Cooking appliance 10 may further include or be in operative communication with a processing device or a controller 50 that may be generally configured to facilitate appliance operation. In this regard, control panel 22, controls 24, and display 28 may be in communication with controller 50 such that controller 50 may receive control inputs from controls 24, may display information using display 28, and may otherwise regulate operation of cooking appliance 10. For example, signals generated by controller 50 may operate cooking appliance 10, including any or all system components, subsystems, or interconnected devices, in response to the position of controls 24 and other control commands. Control panel 22 and other components of appliance 10 may be in communication with controller 50 via, for example, one or more signal lines or shared communication busses. In this manner, Input/Output (“I/O”) signals may be routed between controller 50 and various operational components of appliance 10.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 50 may be constructed without using a microprocessor, e.g., using a combination of discrete analog or digital logic circuitry (such as switches, amplifiers, integrators, comparators, flip-flops, AND/OR gates, and the like) to perform control functionality instead of relying upon software.

Controller 50 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information or data accessible by the one or more processors, including instructions that can be executed by the one or more processors. It should be appreciated that the instructions can be software written in any suitable programming language or can be implemented in hardware. Additionally, or alternatively, the instructions can be executed logically or virtually using separate threads on one or more processors.

For example, controller 50 may be operable to execute programming instructions or micro-control code associated with an operating cycle of cooking appliance 10. In this regard, the instructions may be software or any set of instructions that when executed by the processing device, cause the processing device to perform operations, such as running one or more software applications, displaying a user interface, receiving user input, processing user input, etc. Moreover, it should be noted that controller 50 as disclosed herein is capable of and may be operable to perform any methods, method steps, or portions of methods as disclosed herein. For example, in some embodiments, methods disclosed herein may be embodied in programming instructions stored in the memory and executed by controller 50.

The memory devices may also store data that can be retrieved, manipulated, created, or stored by the one or more processors or portions of controller 50. The data can include, for instance, data to facilitate performance of methods described herein. The data can be stored locally (e.g., on controller 50) in one or more databases or may be split up so that the data is stored in multiple locations. In addition, or alternatively, the one or more database(s) can be connected to controller 50 through any suitable network(s), such as through a high bandwidth local area network (LAN) or wide area network (WAN). In this regard, for example, controller 50 may further include a communication module or interface that may be used to communicate with one or more other component(s) of appliance 10, controller 50, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

In some embodiments, temperature sensor 40 is in operable communication with the controller 50. Accordingly, temperature sensor 40 may deliver signals (e.g., voltage signals) representing the temperature of the cooking surface 14 to controller 50. The signals may be sent according to a predetermined frequency (e.g., at predetermined time intervals). Thus, controller 50 may analyze a temperature or temperature change of the cooking surface 14 and indirectly of the cookware item positioned at the particular heating element (e.g., as described in more detail below).

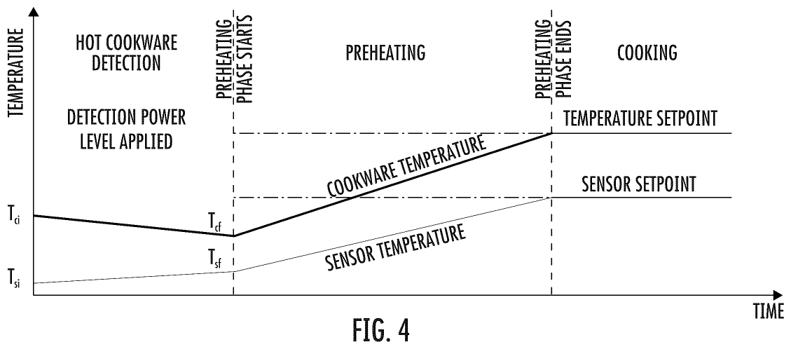

Referring now to FIG. 4, a graph illustrating temperature trends of a sensor temperature and a cookware temperature over a cooking cycle are provided. The sensor temperature may correspond to a temperature value of the cooking surface 14 at a particular heating element 16. For instance, the sensor temperature may be obtained from the temperature sensor 40 corresponding to the particular heating element. The cookware temperature may correspond to a temperature value of a cookware item, such as cookware item 18, positioned over the particular heating element 16. The cookware temperature may correspond to an estimated or determined temperature value. As will be described in more detail below, the cookware temperature may be based on sensor temperature values obtained at predetermined intervals throughout the cooking cycle.

The hot cookware detection operation may be performed across a detection period (e.g., a predetermined amount of time, such as approximately one minute, approximately two minutes, approximately 5 minutes, or the like). The detection period may be initiated as soon as a user input signal corresponding to a temperature setpoint (e.g., a temperature setting or operational setting that a user desires to have an item cooked at) is received at the controller 50. In some embodiments, the cooking appliance 10 must detect a presence of a cookware item 18 prior to initiation of the cooking cycle. In such embodiments, the heating element 16 may be directed to operate at a detection power level during the detection period, corresponding to a power level value capable of detecting cookware presence. When the cookware item 18 is placed over the heating element 16 operating at the detection power level, the heating element 16, or a component thereof may sense a change in an electrical load at the heating element 16. For instance, when the heating element 16 is an induction style heating element, the presence of the cookware item 18 at the cooktop may alter the electric field generated by the coil 17. In this regard, the heating element 16 may be capable of sensing when the electrical properties change and signal to the controller a presence of the cookware item 18.

As may be seen in FIG. 4, the temperature sensor 40 may obtain a first or an initial sensor temperature value Tₛᵢ at the start of the detection period and a second or a final sensor temperature value T_{sf} at the end of the detection period. The initial sensor temperature value and the final sensor temperature value may be used to estimate the final cookware temperature value T_{cf} of the cookware item (e.g., the cookware temperature value at the start of the preheating operation). In some embodiments, the controller 50 may utilize a predetermined or prestored equation, such as a predetermined or prestored regression equation, to determine or estimate the final cookware temperature value T_{cf}. As should be appreciated, the subsequent operations of the cooking cycle (e.g., the preheating operation or the cooking operation) may utilize the final cookware temperature value T_{cf} to more accurately control a cookware temperature of the cookware item 18. In this regard, when a cookware item 18 that has a temperature above the ambient temperature is utilized during the cooking cycle, the controller 50 may advantageously utilize the final cookware temperature value T_{cf} for increased efficiency and a more accurate temperature control (e.g., when compared to cooking cycle without a hot cookware detection operation). During the preheating operation or the cooking operation, the sensor temperature may be continuously utilized in determining or estimating the cookware temperature.

In some embodiments, the preheating operation or the cooking operation are feedback controlled operations of the cooking cycle. For instance, preheating operation or the cooking operation may intelligently adjust one or more parameters according to feedback with respect to cookware item 18, a food being cooked, cooking appliance 10, or the like. Additionally or alternatively, the feedback controlled heating operation may start at the beginning of the preheating operation or the cooking operation. Temperature sensor 40 may continually send temperature signals to controller 50 which may then determine, for instance, an error value associated with the feedback controlled preheating operation or the feedback controlled cooking operation. The error value may be a difference between a temperature setpoint (e.g., sensor temperature setpoint) and an actual observed temperature (e.g., via temperature sensor 40). The error value may be substituted into a feedback equation to determine an adjustment to be made to a control variable. For instance, the control variable may be a power level of heating element 16.

According to at least some embodiments, controller 50 includes a closed-loop feedback control algorithm. The closed-loop feedback control algorithm may be a proportional-integral-derivative (PID) algorithm or equation (e.g., equation or set of equations). In some embodiments, the algorithm may include a proportional algorithm, a proportional-integral algorithm, a proportional-derivative algorithm, or any suitable combination of terms. The PID controller may determine a proportional term (P), an integral term (I), and a derivative term (D). The PID algorithm may be:

$$CV = P + I + D$$

where CV is a controlled variable (e.g., power input to heating element 16), P is the proportional term, I is the integral term, and D is the derivative term. As can be seen, adding each of the P, I, and D terms generates a value for the power level of heating element 16. Each of the P, I, and D terms may be found as follows:

$$P = {K}_{p} * e$$

$$I = {I}_{prev} + {K}_{i} * e * {T}_{s}$$

$$D = {K}_{d} * ( e - {e}_{prev} ) / {T}_{s}$$

where Kₚ is a proportional gain value, Kᵢ is an integral gain value, K_{d} is a derivative gain value, e is an error value (e.g., a difference between a temperature setpoint and an observed temperature), Tₛ is a sampling time or sampling time rate (e.g., a rate at which a discrete system samples inputs), Iₚᵣₑᵥ is a previous integral term (e.g., at the previous sampling event), and eₚᵣₑᵥ is a previous error value (e.g., at the previous sampling event). As noted above, however, in some instances any suitable combination of P, I, and D terms may be incorporated into the algorithm.

Now that the construction of cooking appliance 10 and a configuration of controller 50 according to exemplary embodiments have been presented, exemplary method 300 of operating a cooking appliance will be described. Although the discussion below refers to the exemplary method 300 of operating cooking appliance 10, one skilled in the art will appreciate that the exemplary method 300 is applicable to the operation of a variety of other cooking appliances. In exemplary embodiments, the various method steps as disclosed herein may be performed by controller 50 or a separate, dedicated controller. Additionally or alternatively, the various method steps may be performed in a different order, including additional steps or omitting certain steps according to specific embodiments.

At 310, the method 300 may include obtaining a temperature setpoint corresponding to a cooking cycle or operational characteristics of the cooking cycle. For instance, the temperature setpoint may correspond to a temperature at which a user desires to have an item cooked. In some embodiments, obtaining the temperature setpoint includes receiving a user input signal corresponding to the temperature setpoint. The user input signal may be received in response to a user's communication with the cooking appliance. For instance, a user may communicate with the cooking appliance a desire to initiate a cooking cycle. In particular, the user manually enters a temperature setpoint (e.g., a temperature at which the user desires to have the item cooked). Thus, using a user interface of the cooking appliance, the user may enter a specific cooking temperature as the temperature setpoint (e.g., 250° F., 300° F., 350° F., etc.). In additional or alternative embodiments, the user may provide information regarding a specific food item to be cooked (e.g., eggs, meat, vegetables, etc.). For instance, the cooking appliance may include features for selecting predetermined food items from the user interface or the cooking appliance may include a remote connectivity (e.g., wireless fidelity [WiFi], Bluetooth®, etc.), through which the user may select a food item (e.g., via a remote device). Further still, the user may input a particular recipe to be cooked on or in the cooking appliance. The corresponding temperature setpoint may be stored within the cooking appliance (e.g., within a controller or a memory therein).

At 320, the method 300 may include initiating a hot cookware detection operation across a detection period in response to obtaining the temperature setpoint. As described herein, the “hot cookware detection operation” may correspond to a calibration mode, phase, or period, of the cooking cycle. In particular, the hot cookware detection operation may be utilized to determine or estimate the temperature of a cookware item positioned over a heating element of the cooking appliance. Notably, the determination or estimate of the cookware temperature advantageously improves the efficiency and accuracy of the cooking cycle, and more particularly, the preheating phase or the cooking phase of the cooking cycle, for instance, when compared to the efficiency and accuracy of existing cooking cycles.

In some embodiments, initiating the hot cookware detection optionally includes detecting a presence of a cookware item. Detecting a presence of the cookware item may include directing at least one heating element at a detection power level. The detection power level may correspond to a power level (e.g. an amount of current passing through the coil of the at least one heating element) that is required to induce an electrical current in a cookware item. In this regard, the detection power level may be a relatively low power level of the at least one heating element. For example, the detection power level may correspond to a power level that is approximately one percent of the maximum power level of the at least one heating element. Moreover, detecting the presence of the cookware item may include monitoring a sensor signal of a detector associated with a heating coil of the at least one heating element. For instance, the sensor signal may be monitored to determine a change in load over the heating coil. For example, when a cookware item is placed over the heating coil operating at the detection power level, electrical properties of the heating coil may change or be altered due to the presence of the cookware item. In this regard, the controller may utilize the monitored sensor signal to detect when a cookware item is present over a heating coil.

At 330, the method 300 may include obtaining, at a temperature sensor, a first temperature value corresponding to the cooking surface at a start of the detection period. As described above, the at least one heating element may include a temperature sensor configured to selectively sense a temperature of the cooktop. At the start of the detection period, the temperature sensor may obtain the first temperature value and transmit the first temperature value corresponding to the cooking surface to the controller. In additional or alternative embodiment, the method 300 may include initiating a countdown timer in response to obtaining the temperature setpoint (e.g., subsequent to initiating the hot cookware detection operation). The countdown timer may represent a time delay before the first temperature value is obtained. For instance, the countdown timer may correspond to a portion of the detection period, such as less than ten percent, less than twenty percent, less than twenty-five percent, or the like of the detection period. In such embodiments, the first temperature value is obtained upon a timeout condition of the countdown timer being met. The countdown timer may advantageously improve the accuracy of the first temperature value. For instance, a delay in the reading of the first temperature value may mitigate or prevent slow response times from the temperature sensor.

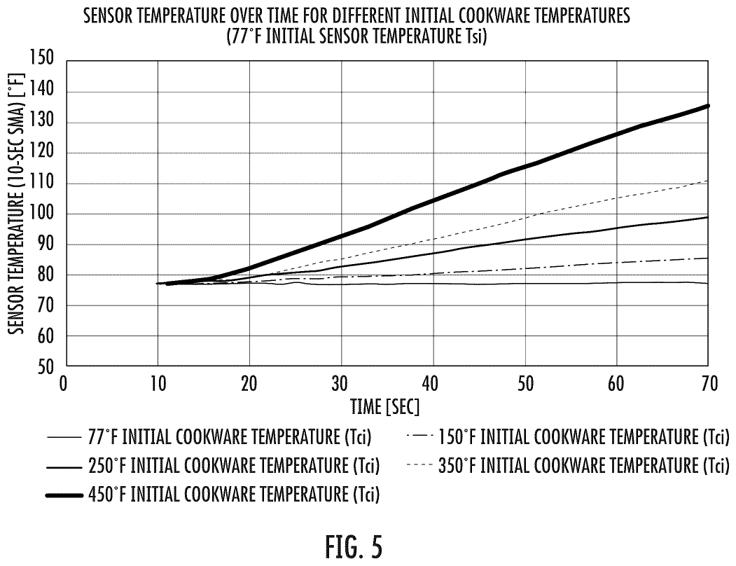

At 340, the method 300 may include obtaining, at the temperature sensor, a second temperature value corresponding to the cooking surface at an end of the detection period. For instance, at the end of the detection period, the temperature sensor may obtain the second temperature value and transmit the second temperature value corresponding to the cooking surface to the controller. When a hot cookware item is placed over the at least one heating element, the hot cookware item may cause the temperature value obtained from the temperature sensor to change over time. For example, FIG. 5 depicts a graph illustrating the temperature value obtained by the temperature sensor over time for different initial cookware temperatures. The temperature value obtained by the temperature sensor may change over the detection period, for instance, for initial cookware temperature (e.g., T_{ci}) of 77° F., 150° F., 250° F., 350° F., and 450° F., and with the same initial sensor temperature (Tₛᵢ) of 77° F. As may be seen in FIG. 5, the higher the cookware item's initial temperature, the larger the change in the obtained sensor temperature value across the detection period. In this regard, the amount of change in the temperature value (e.g., the difference between the initial sensor temperature and the final sensor temperature) across the detection period may be used to determine or estimate the temperature of the cookware item at the end of the detection period (T_{cf}).

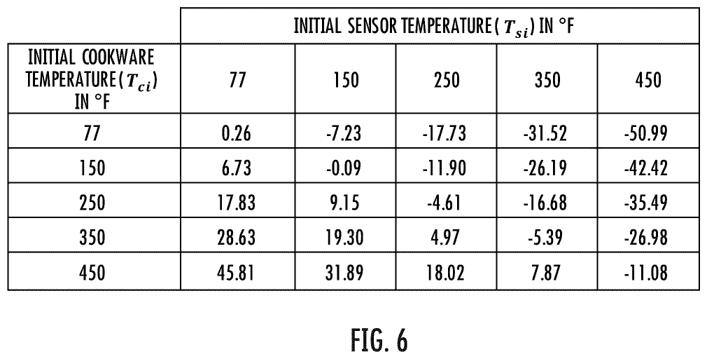

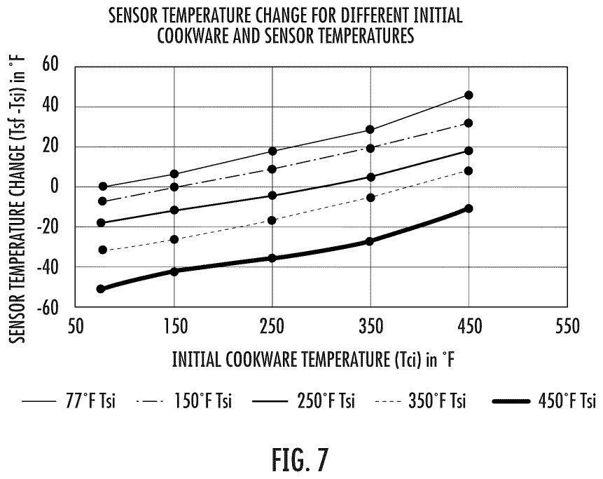

However, in some instances, the initial sensor temperature may be higher than the initial cookware temperature. For instance, a previous cooking cycle wherein at least one heating element was operated at a temperature higher than the initial cookware temperature of the current cooking cycle may occur. In such instances, the temperature value obtained by the temperature sensor may decrease across the detection period. For example, as may be seen in FIGS. 6 and 7, the temperature value obtained at the temperature sensor corresponds to the temperature of the cooking surface (e.g., due to the location of the temperature sensor). In some instances, the temperature value obtained at the temperature sensor may be higher than the ambient temperature if the heating element has been previously utilized.

At 350, the method 300 may include determining, based on the first temperature value and the second temperature value, a temperature change at the cooking surface. For instance, upon completion of the detection period, the difference between the second temperature value and the first temperature value may be calculated. The difference between the temperature values may represent the temperature change at the cooking surface from start to finish of the hot cookware detection period.

In general, a magnitude of the temperature change at the cooking surface from start to finish of the hot cookware detection operation may be proportional to a magnitude of a difference between the initial cookware temperature (T_{ci}) and the initial sensor temperature (Tₛᵢ). In other words, the larger the difference between the initial cookware temperature (T_{ci}) and the initial sensor temperature (Tₛᵢ), the larger the magnitude of the temperature change. For example, as may be seen in FIGS. 6 and 7, a temperature change of 31.89° F. for an initial cookware temperature (T_{ci}) of 450° F. and an initial sensor temperature (Tₛᵢ) of 150° F. may be larger than the temperature change of −0.09° F. for an initial cookware temperature (T_{ci}) of 150° F. and initial sensor temperature (Tₛᵢ) of 150° F. It may also be appreciated in FIGS. 6 and 7 that the magnitude of the temperature change at the cooking surface from start to finish of the hot cookware detection operation may also be larger when the initial sensor temperature (Tₛᵢ) and the initial cookware temperature (T_{ci}) are much higher than the ambient temperature.

At 360, the method 300 may include determining, based on at least one of the temperature change, the first temperature value, and the second temperature value, a cookware temperature value at the end of the hot cookware detection period (T_{cf}). The cookware temperature value may correspond to a temperature of a cookware item at the cooking surface. The cookware temperature value may be determined or calculated by the controller in any suitable manner. For example, using at least one of the temperature change, the first temperature value, and the second temperature value as independent variables in a regression equation stored within a memory of the controller, the temperature of the cookware item may be determined or estimated at the controller. As will be appreciated in more detail below, the temperature of the cookware item may be utilized in the preheating and cooking operations of the cooking cycle, for instance, to advantageously improve the efficiency and accuracy of the cooking cycle.

Further, the method 300 may include directing the at least one heating element according to a preheating operation of the cooking cycle in response to determining the cookware temperature value. For example, as may be seen in FIG. 4, the preheating operation may be initiated upon completion of the hot cookware detection operation. Directing the at least one heating element according to the preheating operation may include directing, based on the temperature setpoint and the cookware temperature value, the at least one heating element according to the preheating operation. For example, the controller may utilize at least one of the temperature setpoint or the cookware temperature value that has previously been obtained or determined to set or adjust a power level of the at least one heating element during the preheating operation. In some embodiments, the preheating operation includes directing the heating element according to a closed-loop feedback control algorithm. The closed-loop feedback control algorithm may be a proportional-integral-derivative (PID) algorithm or equation (e.g., described in more detail above). In such embodiments, at least one of the temperature setpoint or the cookware temperature value is utilized within the PID algorithm or equation. The PID algorithm can be utilized to continuously monitor the cookware temperature and adjust or alter a power level of the at least one heating element as needed.

The method 300 may also include directing the at least one heating element according to a cooking operation in response to or upon completion of the preheating operation. For example, as may be seen in FIG. 4, the cooking operation may be initiated upon completion of the preheating operation. The direction of the at least one heating element according to the cooking operation may be based on the temperature setpoint and the cookware temperature value. For example, the controller may utilize at least one of the temperature setpoint or the cookware temperature value that has previously been determined or obtained to set or adjust a power level of the at least one heating element during the cooking operation. In some embodiments, the cooking operation includes directing the heating element according to a closed-loop feedback control algorithm. The closed-loop feedback control algorithm may be a proportional-integral-derivative (PID) algorithm or equation (e.g., described in more detail above). In such embodiments, at least one of the temperature setpoint or the cookware temperature value is utilized within the PID algorithm or equation. The PID algorithm can be utilized to continuously monitor the cookware temperature and adjust or alter a power level of the at least one heating element as needed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, the cooking appliance comprising:
at least one heating element configured for selectively supplying heat to a cookware item placed on a cooking surface;
a temperature sensor configured to selectively monitor a temperature of the cooking surface; and
a controller operably connected with the at least one heating element and the temperature sensor, the controller configured for performing operations, the operation comprising:
obtaining a temperature setpoint,
initiating a hot cookware detection operation across a detection period in response to obtaining the temperature setpoint,
obtaining, at the temperature sensor, a first temperature value corresponding to the cooking surface at a start of the detection period,
obtaining, at the temperature sensor, a second temperature value corresponding to the cooking surface at an end of the detection period,
determining, based on the first temperature value and the second temperature value, a temperature change at the cooking surface, and
determining, based on at least one of the temperature change, the first temperature value, and the second temperature value, a cookware temperature value, the cookware temperature value corresponding to a temperature of a cookware item at the cooking surface.

2. The cooking appliance of claim 1, wherein obtaining the temperature setpoint comprises receiving a user input signal corresponding to the temperature setpoint.

3. The cooking appliance of claim 1, further comprising:
initiating a countdown timer in response to obtaining the temperature setpoint,
wherein the first temperature value is obtained upon a timeout condition of the countdown timer being met.

4. The cooking appliance of claim 1, further comprising:
directing the at least one heating element at a predetermined detection power level in response to initiating the hot cookware detection operation.

5. The cooking appliance of claim 1, further comprising:
directing the at least one heating element according to a heating operation in response to determining the cookware temperature value.

6. The cooking appliance of claim 5, wherein directing the at least one heating element according to the heating operation comprises
directing, based on the temperature setpoint and the cookware temperature value, the at least one heating element according to a preheating phase of the heating operation.

7. The cooking appliance of claim 6, wherein the preheating phase of the heating operation comprises a proportional-integral-derivative (PID) algorithm.

8. The cooking appliance of claim 6, wherein directing the at least one heating element according to the heating operation further comprises
directing, based on the temperature setpoint and the cookware temperature value, the at least one heating element according to a cooking phase of the heating operation upon completion of the preheating phase.

9. The cooking appliance of claim 8, wherein the cooking phase of the heating operation comprises a proportional-integral-derivative (PID) algorithm.

10. The cooking appliance of claim 1, wherein the temperature sensor is in direct contact with the cooking surface, and
wherein the temperature sensor is positioned under the cooking surface.

11. A method of operating a cooking appliance comprising:
obtaining a temperature setpoint;
initiating a hot cookware detection operation across a detection period in response to obtaining the temperature setpoint;
obtaining, by a temperature sensor, a first temperature value corresponding to a cooking surface at a start of the detection period;
obtaining, by the temperature sensor, a second temperature value corresponding to the cooking surface at an end of the detection period;
determining, based on the first temperature value and the second temperature value, a temperature change at the cooking surface; and
determining, based on at least one of the temperature change, the first temperature value, and the second temperature value, a cookware temperature value corresponding to a temperature of a cookware item at the cooking surface.

12. The method of claim 11, wherein obtaining the temperature setpoint comprises receiving a user input signal corresponding to the temperature setpoint.

13. The method of claim 11, further comprising:
initiating a countdown timer in response to obtaining the temperature setpoint,
wherein the first temperature value is obtained upon a timeout condition of the countdown timer being met.

14. The method of claim 11, further comprising:
directing at least one heating element at a predetermined detection power level in response to initiating the hot cookware detection operation.

15. The method of claim 11, further comprising:
directing at least one heating element according to a heating operation in response to determining the cookware temperature value.

16. The method of claim 15, wherein directing the at least one heating element according to the heating operation comprises
directing, based on the temperature setpoint and the cookware temperature value, the at least one heating element according to a preheating phase of the heating operation.

17. The method of claim 16, wherein the preheating phase of the heating operation comprises a proportional-integral-derivative (PID) algorithm.

18. The method of claim 16, wherein directing the at least one heating element according to the heating operation further comprises
directing, based on the temperature setpoint and the cookware temperature value, the at least one heating element according to a cooking phase of the heating operation upon completion of the preheating phase.

19. The method of claim 18, wherein the cooking phase of the heating operation comprises a proportional-integral-derivative (PID) algorithm.

20. The method of claim 11, wherein the temperature sensor is in direct contact with the cooking surface, and
wherein the temperature sensor is positioned under the cooking surface.
